(19) United States
(12) Patent Application Publication
(10) Pub. No.: US 2005/0026299 A1
(43) Pub. Date: Feb. 3, 2005

(54) Chemical arrays on a common carrier

(76) Inventors: Arindam Bhattacharjee, Andover, MA (US); John F. Corson, Mountain View, CA (US); J. Robert Mitchell, San Francisco, CA (US); George P. Tsai, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/786,557

(22) Filed: Feb. 24, 2004

Related U.S. Application Data
(63) Continuation-in-part of application No. 10/632,332, filed on Jul. 31, 2003, now abandoned.

(51) Int. Cl. G01N 21/00

(52) U.S. Cl. 436/169

(57) ABSTRACT

A set of chemical arrays held together by a common carrier with one or more arrays of the set having been previously exposed to a sample. In one embodiment the common carrier optionally includes an indication of locations along which the carrier should be separated so as to separate the set of chemical arrays into multiple sub-sets each with one or more arrays. A method of use may include separating the set of chemical arrays into multiple sub-sets each with one or more arrays.

### CROSS-REFERENCE

This application is a continuation-in-part application of application Ser. No. 10/632,332, filed Jul. 31, 2003, and titled “Chemical Arrays On a Common Carrier”, which is incorporated herein by reference in its entirety.

### FIELD OF THE INVENTION

This invention relates to arrays, for example polynucleotide arrays such as DNA arrays, which are useful in diagnostic, screening, gene expression analysis, and other applications.

### BACKGROUND OF THE INVENTION

Chemical arrays such as biopolymer arrays (for example polynucleotide array such as DNA or RNA arrays), are known and are used, for example, as diagnostic or screening tools. Such arrays include regions of usually different sequence polynucleotides arranged in a predetermined configuration on a substrate. These regions (sometimes referenced as “features”) are positioned at respective locations (“addresses”) on the substrate. The arrays, when exposed to a sample, will exhibit an observed binding pattern. This binding pattern can be detected upon interrogating the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample.

Biopolymer arrays can be fabricated by depositing previously obtained biopolymers onto a substrate, or by in situ synthesis methods. The in situ fabrication methods include those described in U.S. Pat. No. 5,449,754 for synthesizing peptide arrays, and in U.S. Pat. No. 6,180,351 and WO 98/41531 and the references cited therein for synthesizing polynucleotide arrays. Further details of fabricating biopolymer arrays are described in U.S. Pat. Nos. 6,242,266, US 6,232,072, US 6,180,351, and US 6,171,797. Other techniques for fabricating biopolymer arrays include known light directed synthesis techniques. Methods for sample preparation, labeling, and hybridizing are disclosed for example in U.S. Pat. Nos. 6,201,112, US 6,132,997, US 6,235,483, and US patent publication 20020192650.

In array fabrication, the probes formed at each feature is usually are expensive. Additionally, sample quantities available for testing are usually also very small and it is therefore desirable to simultaneously test the same sample against a large number of different probes on an array. These conditions make it desirable to produce arrays with large numbers of very small (for example, in the range of tens or one or two hundred microns diameter), closely spaced features (for example many thousands of features). After an array has been exposed to a sample, the array is read with a reading apparatus (such as an array “scanner”) which detects the signals (such as a fluorescence pattern) from the array features. Such a reader should typically have a very fine resolution (for example, in the range of one to 100 microns). The signal image resulting from reading the array can then be digitally processed to evaluate which regions (pixels) of read data belong to a given feature as well as the total signal strength from each of the features. The foregoing steps, separately or collectively, are referred to as “feature extraction”.

The present inventors recognize though that handling of fluids and the like for chemical arrays may be similar in practice to fluid handling in other laboratory methods. For example, standard format 96 well plates are commonly used in biochemistry labs. However, chemical arrays are typically read by specialized array reader apparatus which many users already have available to them, but which typically do not accommodate a standard format such as the 96 well plate format. The present inventors further recognize that it would be desirable if arrays could be handled by laboratory equipment for fluid handling (such as sample exposure) or other handling and which equipment may accept a particular format, while still being read in an apparatus which may not accommodate that particular format.

### SUMMARY OF THE INVENTION

The present invention then, provides in one aspect a method of using a set of chemical arrays held together by a common carrier with one or more arrays of the set having been previously exposed to a sample. This aspect may include separating the set of chemical arrays into multiple sub-sets each with one or more arrays. In another aspect the present invention provides an apparatus which includes a common carrier and a set of chemical arrays which are held together by the common carrier. The common carrier may include an indication of locations along which the carrier should be separated so as to separate the set of chemical arrays into multiple sub-sets each with one or more arrays. Computer program products with program code which can execute a method of the present invention, may further be provided.

Different embodiments of the present invention may provide any one or more of the following, or other, useful benefits. For example, arrays may be arranged for handling by laboratory equipment for fluid handling or other handling and which equipment may accept a particular format, while still being read in an apparatus which may not accommodate that particular format.

### BRIEF DESCRIPTION OF THE DRAWINGS

Embodiments of the invention will now be described with reference to the following drawings in which:

FIG. 1 illustrates an embodiment of an apparatus of the present invention in the form of a set of chemical arrays held together by a common carrier in the form of a one-piece substrate on which the arrays are disposed;

FIG. 2 is an enlarged view of two different types of arrays that may be present on an apparatus of FIG. 1;

FIG. 3 is an enlarged view of a portion of an array of FIG. 2.

FIG. 4 is a view similar to FIG. 1 but illustrating an alternate embodiment of the apparatus;

FIG. 5 is a cross-section along the line 5-5 of FIG. 4;

FIG. 6 is a top view of separated sub-sets of arrays from the apparatus of FIG. 1 or 5, each separated sub-set carried on a separate substrate section;

FIG. 7 is a flowchart illustrating embodiments of methods of the present invention;

FIG. 8 is a view of an exemplary well plate that may be used with the arrays of the present invention;

FIGS. 9A and 9B illustrate exemplary components and direction of assembly of reaction assemblies in accordance with the present invention;

FIGS. 10A and 10B illustrate side views of the assembled reaction assemblies of FIGS. 9A and 9B; and

FIGS. 11A-11C illustrate cross sectional views of reaction assembly embodiments held together with a cover assembly and a base assembly.

To facilitate understanding, identical reference numerals have been used, where practical, to designate the same elements which are common to different figures. Drawings are not necessarily to scale. Throughout this application any different members of a generic class may have the same reference number followed by different letters (for example, arrays 12a, 12b, 12c, and 12d may generically be referenced as “arrays 12”)

### DETAILED DESCRIPTION OF EMBODIMENTS OF THE INVENTION

Throughout the present application, unless a contrary intention appears, the following terms refer to the indicated characteristics.

A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. Specifically, a “biopolymer” includes DNA (including cDNA), RNA and oligonucleotides, regardless of the source.

A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.

An “oligonucleotide” generally refers to a nucleotide multimer of about 10 to 100 nucleotides in length, while a “polynucleotide” includes a nucleotide multimer having any number of nucleotides.

A chemical “array”, unless a contrary intention appears, includes any one, two or three-dimensional arrangement of addressable regions bearing a particular chemical moiety or moieties (for example, biopolymers such as polynucleotide sequences) associated with that region. For example, each region may extend into a third dimension in the case where the substrate is porous while not having any substantial third dimension measurement (thickness) in the case where the substrate is non-porous. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). An array feature is generally homogenous in composition and concentration and the features may be separated by intervening spaces (although arrays without such separation can be fabricated). In the case of an array, the “target” will be referenced as a moiety in a mobile phase (typically fluid), to be detected by probes (“target probes”) which are bound to the substrate at the various regions. However, either of the “target” or “target probes” may be the one which is to be detected by the other (thus, either one could be an unknown mixture of polynucleotides to be detected by binding with the other).

An “array layout” or “array characteristics”, refers to one or more physical, chemical or biological characteristics of the array, such as positioning of some or all the features within the array and on a substrate, one or more feature dimensions, or some indication of an identity or function (for example, chemical or biological) of a moiety at a given location, or how the array should be handled (for example, conditions under which the array is exposed to a sample, or array reading specifications or controls following sample exposure).

“Hybridizing” and “binding”, with respect to polynucleotides, are used interchangeably.

A “plastic” is any synthetic organic polymer of high molecular weight (for example at least 1,000 grams/mole, or even at least 10,000 or 100,000 grams/mole.

“Flexible” with reference to a substrate or substrate web (including a housing or one or more housing component such as a housing base and/or cover), reference that the substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C. “Rigid” refers to a substrate (including a housing or one or more housing component such as a housing base and/or cover) which is not flexible, and is constructed such that a segment about 2.5 by 7.5 cm retains its shape and cannot be bent along any direction more than 60 degrees (and often not more than 40, 20, 10, or 5 degrees) without breaking.

A “web” references a long continuous piece of substrate material having a length greater than a width. For example, the web length to width ratio may be at least 5/1, 10/1, 50/1, 100/1, 200/1, or 500/1, or even at least 1000/1.

When one item is indicated as being “remote” from another, this is referenced that the two items are at least in different buildings, and may be at least one mile, ten miles, or at least one hundred miles apart. When different items are indicated as being “local” to each other they are not remote from one another (for example, they can be in the same building or the same room of a building). “Communicating”, “transmitting” and the like, of information reference conveying data representing information as electrical or optical signals over a suitable communication channel (for example, a private or public network, wired, optical fiber, wireless radio or satellite, or otherwise). Any communication or transmission can be between devices which are local or remote from one another. “Forwarding” an item refers to any means of getting that item from one location to the next, whether by physically transporting that item or using other known methods (where that is possible) and includes, at least in the case of data, physically transporting a medium carrying the data or communicating the data over a communication channel (including electrical, optical, or wireless). “Receiving” something means it is obtained by any possible means, such as delivery of a physical item (for example, an array or array carrying package). When information is received it may be obtained as data as a result of a transmission (such as by electrical or optical signals over any communication channel of a type mentioned herein), or it may be obtained as electrical or optical signals from reading some other medium (such as a magnetic, optical, or solid state storage device) carrying the information. However, when information is received from a communication it is received as a result of a transmission of that information from elsewhere (local or remote).

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. Items of data are “linked” to one another in a memory when a same data input (for example, filename or directory name or search term) retrieves those items (in a same file or not) or an input of one or more of the linked items retrieves one or more of the others. In particular, when an array layout is “linked” with an identifier for that array, then an input of the identifier into a processor which accesses a memory carrying the linked array layout retrieves the array layout for that array.

A “computer”, “processor” or “processing unit” are used interchangeably and each references any hardware or hardware/software combination which can control components as required to execute recited steps. For example a computer, processor, or processor unit includes a general purpose digital microprocessor suitably programmed to perform all of the steps required of it, or any hardware or hardware/software combination which will perform those or equivalent steps. Programming may be accomplished, for example, from a computer readable medium carrying necessary program code (such as a portable storage medium) or by communication from a remote location (such as through a communication channel).

A “memory” or “memory unit” refers to any device which can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

An array “assembly” may be only the arrays on the one-piece substrate or different substrate sections, although the assembly may include other features (such as a housing with a chamber from which the substrate sections can be removed). “Array unit” may be used interchangeably with “array assembly”.

“Reading” signal data from an array refers to the detection of the signal data (such as by a detector) from the array. This data may be saved in a memory (whether for relatively short or longer terms).

A “package” is one or more items (such as an array assembly optionally with other items) all held together (such as by a common wrapping or protective cover or binding). Normally the common wrapping will also be a protective cover (such as a common wrapping or box) which will provide additional protection to items contained in the package from exposure to the external environment. In the case of just a single array assembly a package may be that array assembly with some protective covering over the array assembly (which protective cover may or may not be an additional part of the array unit itself).

It will also be appreciated that throughout the present application, that words such as “cover”, “base” “front”, “back”, “top”, “upper”, and “lower” are used in a relative sense only.

“May” refers to optionally.

When two or more items (for example, elements or processes) are referenced by an alternative “or”, this indicates that either could be present separately or any combination of them could be present together except where the presence of one necessarily excludes the other or others.

Any recited method can be carried out in the order of events recited or in any other order which is logically possible. Reference to a singular item, includes the possibility that there are plural of the same item present. All patents and other references cited in this application, are incorporated into this application by reference except insofar as anything in those patents or references, including definitions, conflicts with anything in the present application (in which case the present application is to prevail).

In methods or apparatus described herein, the common carrier which holds the set of arrays together may be rigid or flexible. In one situation the common carrier may be a one-piece substrate having a surface on which the arrays are disposed. An indication of locations along which separating occurs may then include markings on the substrate prior to the separating. For example, the common carrier may be a glass substrate carrying the arrays on a surface, and the markings may include printed lines on the substrate or scores on the substrate to facilitate breaking of the glass. In another situation the common carrier may include a substrate holder, and the sub-sets of arrays may each be carried on separate substrates mounted at different locations on the holder. In this situation the separating may simply be removing the separate substrates from the holder. The indication of the locations along which the carrier should be separated in this situation may be a visual indication of locations at which the separate substrates may be removed from the holder. For example, there may be a visible line between the separate substrates, or there may be some means for removal of each separate substrate which provides the visual indication. In any event, the apparatus may include multiple array identifiers which are positioned on the one-piece substrate or separate substrates before the separating such that after the separating each separated sub-set of arrays is carried on a separate substrate along with at least one of the array identifiers.

Various configurations of the set of arrays held together by the common carrier are possible. For example, the sub-sets of arrays which are separated may be arranged in two directions on the common carrier cross-wise to one another before the separating. The set of arrays on the common carrier before the separating may consist of 2n by 3n arrays on the carrier, where n is some integer such as 4, 8, or 16, or more generally 4x where x is an integer from 1 to 5, 10, or 20 (for example, 5, 6, 7, 8, 9, 10, 11, 12 or 16). The common carrier may have a length and width which is equal to that of any common laboratory sample device, such as no greater than 150 mm or 130 mm, by 100 mm or 90 mm, to allow compatibility with the well known standard 96, 384, or 1536 well microtiter plate format.

Further, in any event the apparatus may be received from a remote location in any of the formats described herein, before the separating. The set of arrays as so received may or may not have been exposed to a sample. Methods of the present invention may include the exposing of the arrays to one or more different or same fluids, such as one or more liquid samples, while the set of arrays is held together by the common carrier. As a result of the separating the number of sub-sets may be any desired number as indicated by the visual indication of locations for the separating. For example, the set of arrays may be separated into 2, 4, 6, 8, 10, or 12 sub-sets on separate substrates which all may or may not have the same length and width (that is, the length is the same for all separate substrates, and the width is the same for all separate substrates, but the length and width for a given substrate may be the same or different). In one case the separated substrates may have a width and length such as 2.54 cm by 7.62 cm (1″ by 3″).

Methods of the present invention may further include, following the separating, then separately reading the separated sub-sets of the chemical arrays. Identifiers which are present may be read (before or after the separating) and array layout information retrieved for a separated array sub-set using a read array identifier carried on a same separate substrate as that separated array sub-set. As to computer program products of the present invention, these may include a computer readable medium carrying a computer program which when loaded into a computer executes a method as described herein.

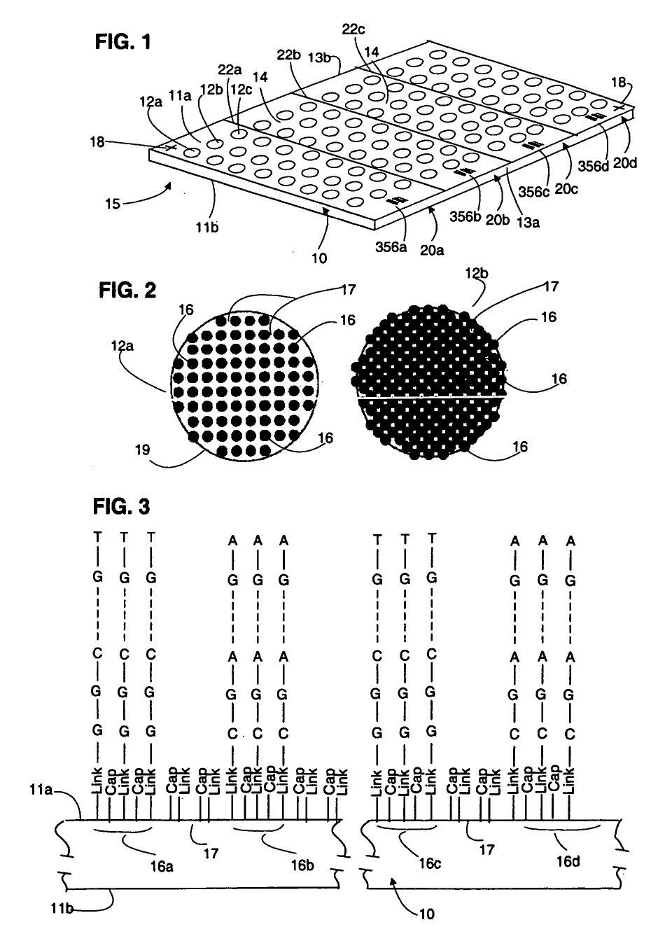

Referring now to FIGS. 1-3, an apparatus of the present invention is shown in the form of an array assembly 15 which may be fabricated using any of those methods already described herein. Array assembly 15 includes a common carrier in the form of a one-piece substrate which can, for example, be in the form of a rigid substrate 10 (for example, a transparent non-porous material such as a single piece of glass or silica) carrying one or more arrays 12 (such as arrays 12a, 12b, 12c) disposed along a flat front surface 11a of substrate 10 and all separated by a same inter-array surface region 14 which surrounds each of arrays 12. Inter-array surface region can be considered to extend just beyond the outermost of arrays 12 in FIG. 1. The continuous region carrying arrays 12 includes the arrays 12 and inter-array region 14. Alternatively, substrate 10 can be flexible. Each array 12 occupies its own region on surface 11a which is co-extensive with the array (hence the regions do not extend into inter-array region 14). A back side 11b of substrate 10 does not carry any arrays 12. The arrays 12 on substrate 10 can be designed for testing against any type of sample, whether: a trial sample; reference sample; a combination of the foregoing; or a known mixture of polynucleotides, proteins, polysaccharides and the like (in which case the arrays may be composed of features carrying unknown sequences to be evaluated).

In the configuration of FIG. 1 substrate 10 has length and width dimensions of 7.62 cm by 10.16 cm and is shown carrying a set of ninety-six arrays 12 arranged in an eight by twelve array format in the same manner as wells of a standard ninety-six well microtiter plate. Front surface 11a of substrate 10 carries indications of locations along which substrate 10 should be separated in the form of straight line scores 22a, 22b, 22c. Scores 22 divide the set of arrays 12 into four sub-sets of twenty-four arrays (each of three by eight arrays) such that when substrate 10 is separated along scores 22, the resulting sections of separated substrate 20a, 20b, 20c, 20d (shown separated in FIG. 6) each have width and length dimensions of 2.54 cm by 7.62 cm (1″ by 3″) and each carries one of the array sub-sets. Substrate 10 further carries multiple (four in FIG. 1) array identifiers 356 in the form of bar codes on front surface 11a such that each section of separated substrate 20a-20d also carries an array identifier 356. Each identifier may be associated with each array 12 by being on the same substrate 10 and therefore having a fixed location in relation to identifier 356 from which relative location the identity of each array can be determined. Each array identifier can either carry array layout information or an identification linked to array layout information in a remote or non-remote memory, for each array on the section 20 which carries that identifier, as well as information on array features, all of which information can be used in a manner the same as described in U.S. Pat. No. 6,180,351 (which as mentioned above, is incorporated herein by reference). Identifiers such as optical, radiofrequency identification (“RF ID”) Tags or magnetic identifiers could be used instead of bar codes. The substrate 10 may further have one or more fiducial marks 18 for alignment purposes during array fabrication and reading.

While ninety-six arrays 12 are shown in FIG. 1, it will be understood that substrate 10 may have any number of desired arrays 12 such as at least ten, thirty, fifty, one hundred, two hundred, or at least one thousand. For example there may be a total of 96, 384, or 1536 arrays laid out in an a 2n by 3n format where n is an integer from 4, 8, or 12 to 20, 30, or 50, such as n being 4, 8, or 16 (or some other whole multiple of 4). Scores 22 may still be positioned as in FIG. 1 to divide substrate 10 into four equal sections of separated substrate 20 when substrate 10 is separated along the scores 22. In this case each section of separated substrate 20 will have the same length and width as described above but each will then carry 2n by 3n/4 arrays 12 when n is a whole multiple of 4.

Depending upon intended use, any or all of arrays 12 may be the same or different from one another and each may contain multiple spots or features 16 of biopolymers in the form of polynucleotides. In the illustrated embodiment arrays 12 are generally round in shape (although other shapes, such as generally elliptical and square, are possible). A typical array 12 may contain from more than five, ten, twenty, thirty, or one hundred features, or even at least one hundred, one thousand, two thousand, or at least four thousand features. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature of the same composition are excluded, the remaining features may account for at least 5%, 10%, or 20% of the total number of features).

Each array 12 may cover an area of less than 200 mm², 100 mm², or less than 50 mm², 20 mm², or less than 10 mm². Arrays 12 may be spaced apart from one another by a distance at least two, three, or four times the average distance between features within the arrays. In many embodiments, particularly when substrate 10 is rigid, it may be shaped generally as a rectangular solid as shown (although other shapes are possible). Other possible dimensions of substrate 10 include those in which it has a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. When substrate 10 is flexible, it may be of various lengths including at least 1 m, at least 2 m, or at least 5 m (or even at least 10 m). With arrays that are read by detecting fluorescence, the substrate 10 may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

In the case where arrays 12 are formed by the conventional in situ or deposition of previously obtained moieties, as described above, by depositing for each feature a droplet of reagent in each cycle such as by using a pulse jet such as an inkjet type head, inter-feature areas 17 will typically be present which do not carry any polynucleotide. It will be appreciated though, that the inter-feature areas 17 could be of various sizes and configurations. Each feature carries a predetermined polynucleotide (which includes the possibility of mixtures of polynucleotides). As per usual, A, C, G, T represent the usual nucleotides. “Link” (see FIG. 3 in particular) represents a linking agent (molecule) covalently bound to the front surface and a first nucleotide, and “Cap” represents a molecule which does not bind to a nucleotide, as further described below.

FIGS. 2 and 3 illustrate ideal features 16 of arrays 12a, 12b where the actual features formed are the same as the target (or “aim”) features, with each feature 16 being uniform in shape, size and composition, and the features being regularly spaced. Such an array when fabricated by drop deposition methods, would require all reagent droplets for each feature to be uniform in shape and accurately deposited at the target feature location. In practice, such an ideal result may be difficult to obtain due to fixed and random errors during fabrication. For illustrative purposes array 12a is shown with features 16 spaced in a rectangular arrangement (that is, regular rows and columns) while array 12b has features 16 spaced in a close hexagonal configuration. In practice, generally the same configuration (rectangular or close hexagonal) will be used for all arrays 12 on the same substrate 10.

One or more of the arrays may be duplicated on surface 11a with the same features, with duplicated arrays having the same or different feature probe densities. All features within a same array in this embodiment have the same feature probe density, with probes bound to surface 11a through linker agents identified as “Link” in FIG. 3. A capping agent (“Cap”) is also present on each of the features 12a-12d. As to a suitable capping agents this may particularly be any of the first silanes as set out in detail U.S. Pat. No. 6,444,268, while the linking agent may be any of the second silanes therein, and the solvent may be as described in that patent also (for example, toluene). As already mentioned, that patent is incorporated herein by reference, including for example the details of the first and second silanes and solvents used therein. In one embodiment as described in the foregoing patent the first silane has the formula R¹—Si(R^{L}R^{x}R^{y}) and the second silane has the formula (before linking to a deposited biomonomer) of R²-(L)ₙ-Si(R^{L}R^{x}R^{y}) so that binding to the surface provides —Si—R¹ groups and —Si-(L)ₙ—R² groups thereon, wherein the R^{L}, moieties, which may be the same or different, are leaving groups, the Rx and Ry are independently lower alkyl or leaving groups, R¹ is a chemically inert moiety that upon binding to the substrate surface lowers the surface energy thereof, n is 0 or 1, L is a linking group, and R² is a functional group enabling covalent binding of a molecular moiety or a modifiable group that may be converted to such a functional group. Leaving groups in the foregoing may include halogen and alkoxy. Both the first and second silanes bind to the surface through reactive hydrophilic moieties thereon, which are selected from the group consisting of hydroxyl, carboxyl, thiol, amino, and combinations thereof. The foregoing terms and other embodiments of the first and second silanes are further defined in the foregoing patent. The substrate 10 may be processed with the foregoing silane mixture as described in detail in U.S. Pat. No. 6,444,268, to obtain hydroxy terminated second silane groups to which nucleotide phosphoramidites can react for binding to the surface through the second silane (the LNK of FIG. 3). This results in the configuration shown in FIGS. 1-3 in which the polynucleotides (or other biopolymer) are bound to substrate surface 11a at features 16 through the LINK molecules. The relative amounts of the first and second silanes can be adjusted to control surface energy (and hence, the degree of hydrophobicity) as also described in detail in U.S. Pat. No. 6,444,268.

In one configuration of the array assembly 15 of FIG. 1, the continuous region of front surface 11a of substrate 10 which includes inter-array surface region 14 and arrays 12, may be physically uninterrupted. Thus the arrays 12 and inter-array region 14 themselves are also physically uninterrupted. Liquid aqueous sample deposited onto each array 12 can be retained on the array as a result of each array 12 being less hydrophobic than inter-array region 14, as a result of the presence of the polynucleotides (with their hydrophilic functional groups) at each feature 16. In this situation each array 12 is effectively surrounded by a surface energy discontinuity which can maintain separation between separate liquid samples applied to the arrays 12, as more fully described in U.S. patent application Ser. No. 10/355,705 titled “Multiple Arrays With Surface Energy Transition To Maintain Separation Of Samples On The Arrays” filed Jan. 31, 2003 by Leproust et al. Alternatively, each array 12 could be surrounded by a surface interruption, such as a circular line of deposited chromium to assist in maintaining separate the liquid samples applied to the different arrays 12.

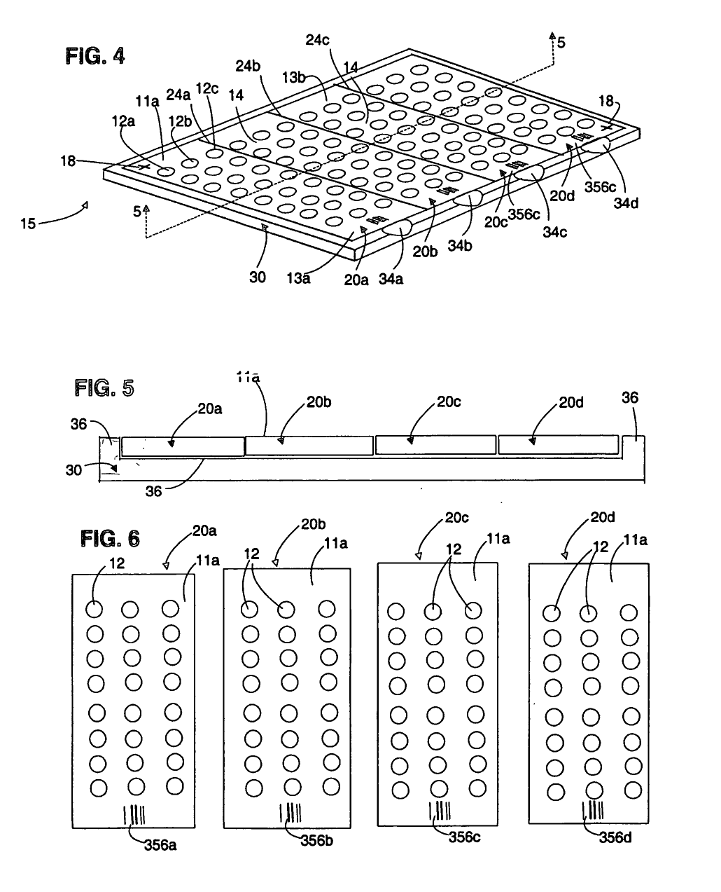

Referring now to FIGS. 4 and 5 another apparatus of the present invention is shown in the form of an alternate array assembly 15. In this embodiment the common carrier is in the form of a solid substrate holder 30 made of plastic, metal, or other suitable material. Substrate holder 30 has a recess in its upper surface into which previously separated sections 20a, 20b, 20c, 20d (as already described in connection with FIG. 1) can be snugly seated so as to be held by holder 30 in a position in which they are arranged in a series each abutting the next as shown in FIGS. 4 and 5 (though they could be arranged in a series each adjacent the next thereby permitting a slight spacing between them). A raised margin 36 surrounding this recess is preferably sized with as small as possible thickness (for example, less than 20, 10, 5, or 1 mm) so that the overall assembly 15 can have dimensions the same or similar to those already described above in connection with one-piece substrate 10 of FIG. 1. Optionally a releasable adhesive can be present on side 11b of each section 20 to assist in holding them within holder 30. In this case the indications of the locations along which separating should take place includes a visual indication of locations at which separate substrates may be removed, in the form of separation lines 24a, 24b, 24c which are visible as a result of sections 20a through 20d being already separated. Additionally, another visual indication of locations at which separate sections of substrate 20 may be removed from holder 30, is provided by access points 34a, 34b, 34c, 34d which accommodate a user's fingertip to allow a section 20 to be pried upward and out of holder 30. The removed separated sections of substrate 20 again are shown in the top view of FIG. 6.

Alternatively, in the embodiment of FIGS. 4 and 5 the sections 20a, 20b, 20c, 20d may not be previously separated in holder 30. That is, the a rigid one-piece substrate such as that of FIG. 1 may instead be seated in holder 30. In this case scores 22 can serve as the visual indications of the locations along which separating should take place.

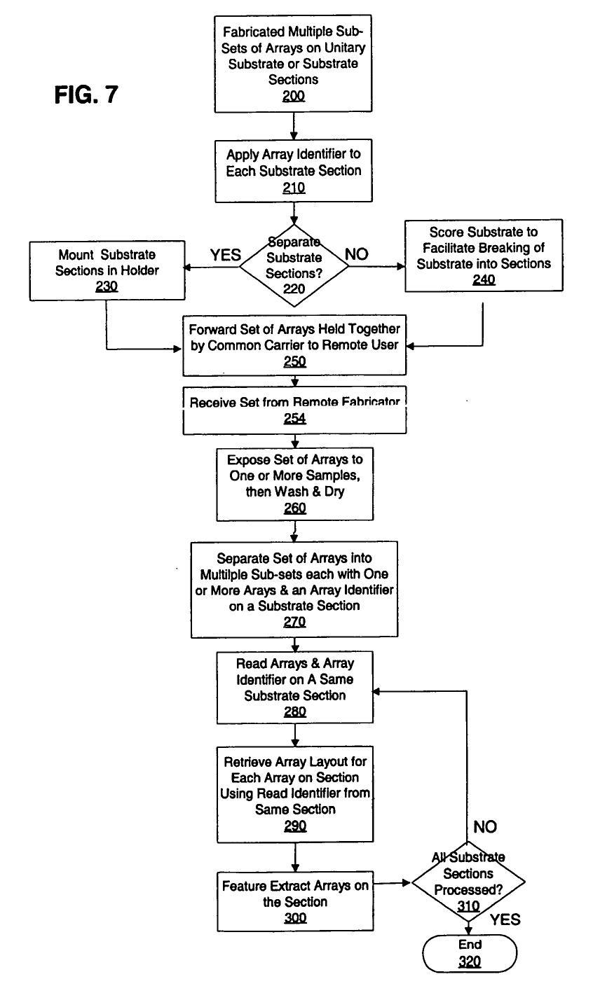

In either of the embodiments of FIGS. 1-5 the length and width of the common carrier (whether the one-piece glass substrate 10 or holder 30) can selected to be about 128 mm by 85 mm which are about the same as those for the well known standard 96, 384, or 1536 well microtiter plate format. This matching of dimensions of the common carrier to those of a standard format, allows the use of existing laboratory automation equipment to handle the common carrier. Embodiments of methods of the present invention will now be described further with reference to FIG. 7. Numbers in parentheses refer to events shown in FIG. 7. Events 200 through 250 may occur at an array fabrication station while events 254 to 320 occur at a user station remote or local to the fabrication station. Optionally, events 254 and 260, with or without event 270, can occur at a lab station while subsequent events occur at a reader station, where any one or any two of the fabrication station, lab station, and reader station, may be remote or local to the remainder of the stations.

In FIG. 7 multiple sub-sets of arrays are fabricated (200) on a one-piece substrate such as in FIG. 1, or alternatively they are fabricated on separate sections 20 (either by originally being so separately fabricated or by the separating of substrate 10 of FIG. 1) as shown in FIG. 6. In either event array identifiers 356 are applied (210) during fabrication and array layout and other information saved in a memory as already described above. If a one-piece substrate 10 of FIG. 1 was fabricated (NO in determination 220) then the indications along which separating is to occur, may be applied to surface 11a in the form of scores 22. If separate sections of substrate 20 were fabricated (YES in determination 220) those separate sections can be mounted (230) in holder 30. Alternatively, as mentioned above, a one-piece substrate 10 of FIG. 1 could be mounted in holder 30 if desired. In any event the resulting set of arrays held together by the common carrier is forwarded (250) to a remote user station. At the user station the set of arrays, while still on the common carrier, may be exposed to one or more fluids either separately to one or more of the same or different fluids, or simultaneously to the same fluid extending over inter-array region 14 (such as by flooding or immersion). Typically this will involve exposing each array simultaneously but separately (that is where the separately exposed samples do not mix with one another) to an aqueous or other liquid sample. All of the arrays 12 may then be simultaneously exposed to a wash liquid as a result of flooding or immersion (such as aqueous buffer solution), and this process repeated. Similarly, all of the arrays 12 may be simultaneously exposed to a nitrogen or other inter gas to dry arrays 12. The set of arrays 12, while still on the common carrier, could then be stored in ambient atmosphere or under controlled conditions (for example, for at least 10 minutes, 30 minutes, 1 hour, 5 hours, or at least 24 hours, in a chamber having an inert gas or other atmosphere free of contaminants and which blocks out at least 25% or 50% of total light between 500 to 200 nm) until shortly before reading. Note that all or any of the foregoing processes can be performed using standard laboratory equipment such as may be used for a standard 96, 96, 384, or 1536 well microtiter plate or other laboratory apparatus. Also standard laboratory equipment, such as that which may be used for handling the foregoing plates, may be used during handling processes (for example, moving the array assembly 15 from place to place). However, other multi-well formats could be used instead.

At this point sections 20 may be separated (270) such as by breaking the substrate 10 along scores 22 in the case of array assembly 15 of FIG. 1, or in the case of array assembly 15 of FIG. 4 simply by inserting a fingertip at access points 34 and prying each section 20 upward out of holder 30. In either event separated sections 20 as shown in FIG. 6 are obtained. In a variation of FIG. 6, not all separated section need be the same size or carry the same number of arrays. For example, in the array assembly of FIG. 1 or FIG. 4 only one section 20 may be separated from the remainder (that is, the three other sections may be attached together in the embodiment of FIG. 1 or seated in holder 30 in the embodiment of FIG. 4). This may be particularly convenient in the event that each of the unseparated sections have not yet been exposed to a sample. In this manner a customer could just use the arrays on a separable section one or more at a time by exposing that section or sections to one or more samples, then separating and reading them, then repeating this process one or more times for previously unseparated sections. However, in many situations all of the arrays on all sections 20 may all have been exposed to one or more samples prior to any separation of a section 20.

Separated sections 20 may then be prepared for reading (280) of the arrays. Depending upon the reader apparatus sections 20 may be read in the format as shown in FIG. 6 or inserted into a suitable holder which may be required by the reader apparatus. One particular reader station is disclosed in U.S. Pat. No. 6,406,849. Further details of such readers are disclosed in U.S. Pat. No. 6,320,196 and U.S. Pat. No. 6,486,457. Another particular reader station that may be used is the AGILENT MICROARRAY SCANNER manufactured by Agilent Technologies, Palo Alto, Calif. In addition to reading the arrays 12 on a section 20 the reader may also read (280) the identifier 356 on the same substrate section 20. The read identifier may be used to retrieve (280) the array layout for each array 12 on the same section 20 carrying that read identifier 356, from a local or remote memory in a manner such as described in U.S. Pat. No. 6,180,351. The read raw signal data which is read from the arrays may then be processed such as by feature extraction (300) and further processing as desired. Examples of feature extraction programs for which instructions or parameters may be provided, include methods or any part of them such as those described in U.S. patent application Ser. No. 10/077,446 titled “Method And System For A Range Of Automatic, Semi-Automatic, And Manual Grid Finding During Feature Extraction From Molecular Array Data”, or Ser. No. 09/589,046 “Method And System For Extracting Data From Surface Array Deposited Features”, or U.S. Pat. No. 5,721,435, all incorporated herein by reference. Following any such processing it can be determined (310) if all desired substrate sections 20 (whether from the same or different array assemblies 15) have been processed in accordance with events (280-300). If YES, the method comes to an end (320). If NO, each section 20 can in turn be processed through events (280-300).

Note that leaving the sections 20 together on the common carrier up until just prior to reading them, can be used in a manner which provides one or more advantages. For example, a user could safely assume that all sections 20 on a common carrier are from the same fabrication run and that they all encountered the same environmental conditions prior to reading (for example, during sample exposure for hybridization, and during wash and storage both before and after sample exposure). Thus, a user could safely assume that sections 20 were not stored or processed separately since they were physically connected by being together on the common carrier, from the time an array assembly was received by the user (or even from the time the sections were fabricated and shipped from a fabrication location to the user) up to the point of their separation immediately preceding their reading.

A results of methods of the present invention may then be used to make an assessment whether one or more targets is present in a sample to which an array was exposed, or whether an organism from which the sample was obtained exhibits a particular condition (for example, gene expression level or cancer). A results (whether raw or processed) may be further forwarded or transmitted to a remote location at which they are received, and can be re-transmitted to elsewhere from that location as desired.

Various and modifications to the particular embodiments described above are, of course, possible. For example, in the embodiment of FIG. 1 scores 22 may be omitted and the user relied on to separate the array by breaking the glass at the appropriate locations. Furthermore, while polynucleotide arrays were referenced in particular in connection with the embodiments of FIGS. 1-6, such polynucleotides can be replaced with other chemical moieties including polymers such as other biopolymers (for example, peptides). Additionally, the common carrier need not be rigid and a configuration such as disclosed in U.S. patent application Ser. No. 09/775,375 filed Jan. 31, 2001, titled “Automation-Optimized Microarray Package” by McEntee et al., could be used (the foregoing application, and particularly FIGS. 2-6 and their description and use, are incorporated herein by reference). Accordingly, the present invention is not limited to the particular embodiments described in detail above.

As noted above, embodiments include exposing a set or sub-set of arrays to one or more fluids, e.g., for simultaneously conducting multiple chemical reactions, such as described in U.S. Pat. No. 6,682,720, the disclosure of which is herein incorporated by reference. Accordingly, such may be accomplished by employing a well plate that includes a plate having a plurality of wells in a surface of the plate, which wells are separated by well spacing, such as, or analogous to, standard format well plates such as standard ninety-six well plate formats also known in the art as microtiter plates. The wells of the well plate are arranged in an array pattern, e.g., corresponding to the pattern of arrays of an array assembly or sub-assembly with which it is intended to be used. In this manner, when a well plate and an array assembly of the subject invention (separated into sections or not) are brought together in an operative association to provide a reaction assembly apparatus, each array is lined-up or rather is positioned over a corresponding well of the plate to provide discrete, closed chambers about each array. The wells of the well plate may include test samples or other reactants for performing a hybridization assay or the like. For example, reagents for performing amplification reactions such as PCR, enzymatic digestions, T7 generated cRNA, polymerase-based extensions, and the like may be positioned inside one or more wells of a multiwell plate. One or more wells may include a quantity or amount of an analyte-digesting reagent. The analyte-digesting agent may be one (or may be a combination of reagents) that digests or cleaves an analyte, i.e., cuts up the analyte into at least two fragments. In certain embodiments, the digesting reagent(s) includes an enzyme that digest or cleave an analyte, i.e., enzymatically digest an analyte, in particular or predictable positions. The multiwell plate may be employed with the subject arrays for primary reactions, as well as secondary reactions such as secondary cellular transvection-type reactions. In such instances, one or more wells of the plate may contain cells, or cells may be added to one or more wells, into which nucleic acid may be transvected. In certain embodiments, each closed chamber may include an array and a respective test sample (and/or other reagent(s)) and may also include a seal about the well, e.g., for providing a gas and/or liquid and/or fluid tight seal. One or more substrates (e.g., a base and/or a cover) may be positioned about the reaction assembly apparatus (i.e., about the well plate/array structure) to maintain the apparatus together in an operative configuration and/or to apply a compression force to the underlying structure, where in certain embodiments an array carrier (such as a substrate 10 or holder 30) may serve as a cover or base.

Accordingly, in certain embodiments, an array assembly (a one-piece substrate having a surface on which arrays are disposed (in a substrate holder or not), or a set of chemical arrays that has been separated into multiple sub-sets of arrays, each carried on separate substrates (held in a substrate holder or not), may be positioned over a well plate such as a standard microtiter plate or the like to provide a sealed chamber about each array.

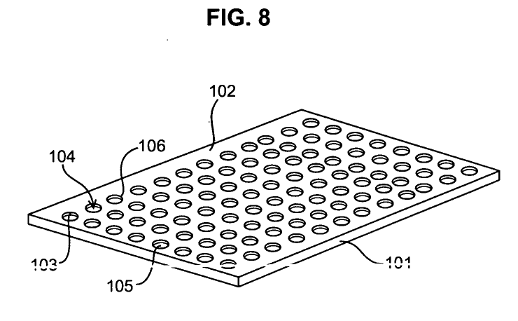

FIG. 8 shows an exemplary embodiment of a well plate that may be used with an array assembly of the subject invention. Plate 101 includes a plurality of wells 104 in a surface 102 of the plate 101 that are separated by a well spacing. The wells are arranged in an array pattern. Each well 104 extends in a thickness dimension of the plate and has a side wall 103 adjacent to a closed end 105 that together enclose all sides of the well except for an open end 106 opposite the closed end 105. The open end 106 is adjacent to the surface 102 of the plate 101 to provide access to the well 104 for receiving a volume of a sample to be used with the array to which the well is to be operatively associated. The sample and/or other reagent(s) in each well 104 may be the same, or may be different in at least one well 104 of the plate 101. Plate 101 may be a standard microtiter plate, having 96, 384, or 1536 wells, or a 9×26 plate having 234 wells on 2.25 mm centers, where these configuration are merely representative as other configurations may be employed as well.

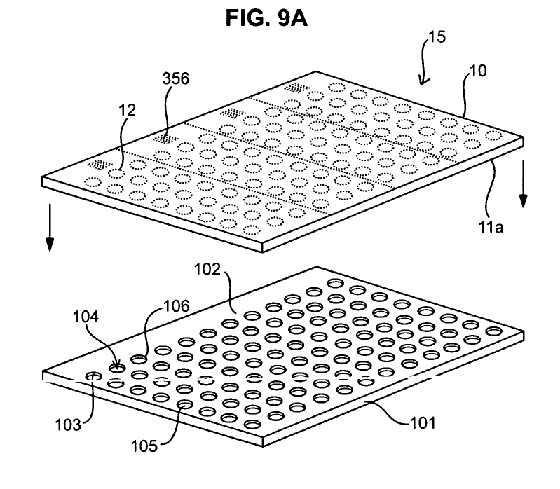

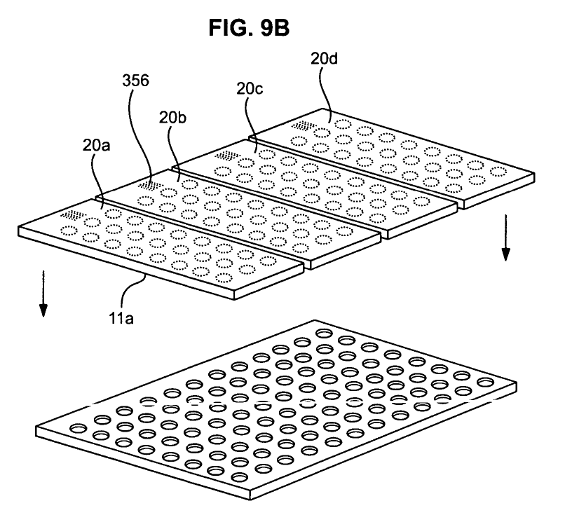

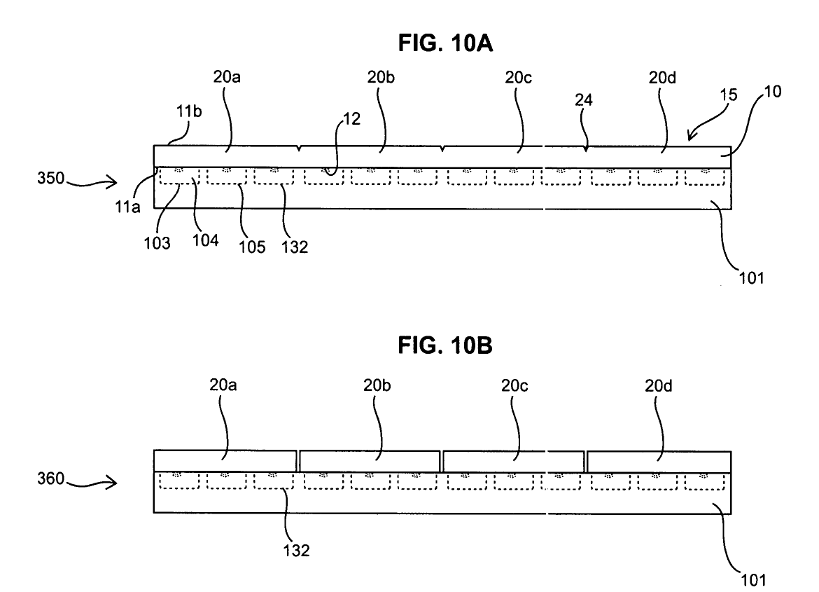

In use, an array assembly or one or more individual array sub-assemblies is contacted with the well plate to provide closed chambers about each array for performing array assays such as hybridization assays or the like. FIGS. 9A-9B and 10A-10B illustrate the use of exemplary well plate 101 with the array assemblies and sub-assemblies of the subject invention. The array assembly or sub-assembly and array pattern are sized, shaped and arranged to interface with plate 101 so as to provide closed chambers about the arrays.

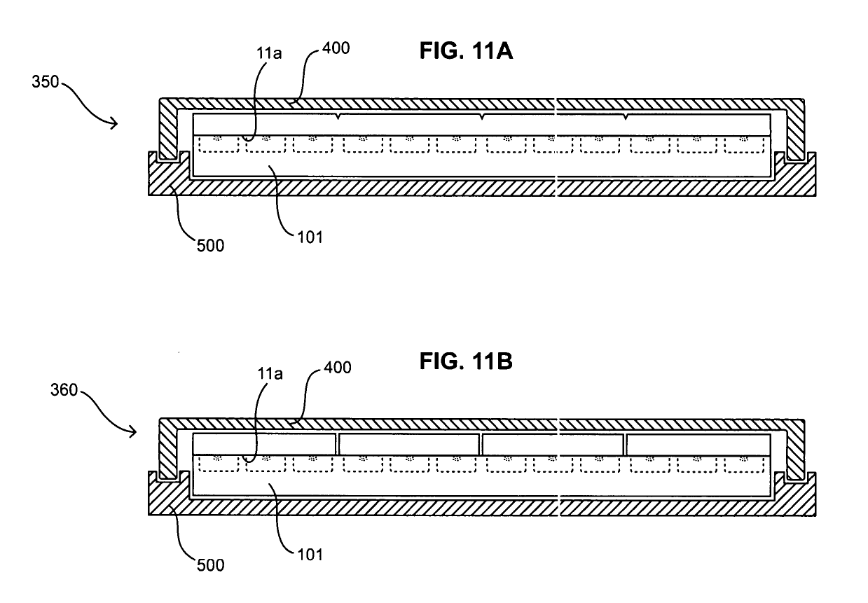

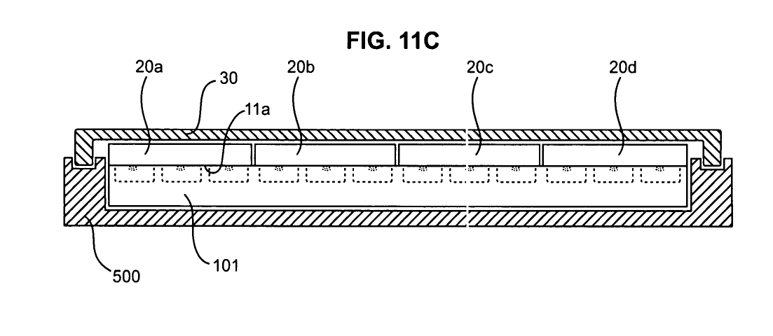

FIG. 9A shows plate 101 and an array assembly 15 that includes a one-piece substrate having a surface on which the arrays are disposed, such as assembly 15 of FIG. 1, in position to be operatively assembled with well plate 101 to form the reaction assembly apparatus 350 of FIG. 10A that includes array assembly 15 and well plate 101 assembled together. FIG. 10A shows a side view of the reaction assembly apparatus 350 formed by assembling together plate 101 and array assembly 15 of FIG. 9A. FIG. 9B shows plate 101 and a plurality of separated substrate sections 20 in position to be operatively assembled with well plate 101 to form the reaction assembly apparatus 360 of FIG. 10B that includes sections 20 and well plate 101 assembled together. FIG. 10B shows a side view of the reaction assembly apparatus 360 formed by assembling together plate 101 and sections 20 of FIG. 9B. While not shown in this particular embodiment, separated sections 20 of FIG. 9B may be held in holder 30 (see for example FIG. 4) prior or subsequent to being associated with the well plate. Likewise, while not shown in the particular embodiment of FIGS. 9A and 10A, the unitary substrate of FIG. 9A may be held in holder 30 prior or subsequent to being associated with the well plate. Embodiments of the reaction assembly apparatus may include an optional base 500 and cover 400 (see for example FIGS. 11A-11C), as will be described in greater detail below.

Accordingly, a substrate having a plurality of arrays, e.g., array assembly 15 of FIGS. 1 and 4 or separated sections 20 of FIG. 6, is placed on plate 101, such that array the wells 104. At this point, the array assembly may be a one-piece substrate, i.e., not yet broken along separation lines 24a, 24b and 24c (see for example FIG. 1), or may be separate substrate sections, i.e., broken along separation lines 24a, 24b and 24c (see for example FIGS. 4, 5 and 6), and in any event may be held or not in an array holder. The unitary array substrate having a set of arrays or sections 20 each having one or more arrays, together with and plate 101, provide a reaction assembly apparatus 350 or 360 having individual closed chambers 132 at each well 104 location. Usually, each well 104 is gas and/or liquid and/or fluid tight. A seal may be positioned about each well and may be accomplished in several ways such as described in U.S. Pat. No. 6,682,702, the disclosure of which, as noted above, is herein incorporated by reference. Once a reaction assembly apparatus is provided, it may be agitated according to U.S. Pat. No. 6,682,702.

As noted above, in certain embodiments a well plate and an array may be held or “sandwiched” together using a housing positionable about an array assembly (or sub-assembly) and a well plate. In many embodiments, the housing includes a base assembly and a cover assembly. Such may be used, for example, in the event that one or more separate substrate sections are positioned on top of a well plate, i.e., one or more of previously separated sections 20 as described above. In such instances, the separate sections may be maintained in place on a well plate using a base assembly and a cover assembly.

A housing is typically shaped and dimensioned to be positionable about a structure characterized by a set of arrays on a common carrier and a well plate. The housing is usually dimensioned to be slightly larger than the underlying structure so that the underlying structure is snugly fit within the housing. The housing may be made of any suitable materials such as plastics, metals, glass, etc., and combinations thereof. A housing may be flexible or rigid, where in certain embodiments a portion may be flexible and a portion may be rigid, e.g., a base may be rigid and a corresponding cover may be flexible, or vice versa.

FIG. 11A shows a cross-sectional view through the embodiment of FIG. 10A and which includes base assembly 400 and cover assembly 500 holding array assembly 15 and plate 101 together. FIG. 11B shows a cross-sectional view through the embodiment of FIG. 10B and which includes base assembly 400 and cover assembly 500 holding sections 20 and plate 101 together. In certain embodiments, a common carrier such as holder 30 may serve as a cover assembly or a base assembly. For example, FIG. 11C shows the embodiment of FIG. 5 operatively positioned on well plate 101 wherein holder 30 serves as a cover assembly. In any event, a base assembly and a cover assembly may be positioned in a closed orientation about an array substrate/well plate structure, e.g., to hold separated sections in place on the well plate.

The housing may be maintained in a closed configuration using any suitable method, e.g., a cover assembly may be grooved (e.g., to accommodate a base assembly having a corresponding tongue), or vice versa, a cover assembly and base assembly may be hinged, snap fit, friction fit, threaded (or round housings), clamped, latched, etc.

Housings suitable for use with the subject invention include, but are not limited to, housings described in (and housings analogous to those described in), U.S. application Ser. Nos. 10/729,606; 10/286,649; and 10/177,192, the disclosures of which are herein incorporated by reference.

Also provided are kits for use in practicing the subject methods. The subject kits may include a set of chemical arrays held together by a common carrier, as described above. The common carrier may be a one-piece substrate or a substrate holder.

Kits may also include one or more multiwell plates, e.g., configured to be used with an array in an array assay such as a hybridization assay or the like. For example, a plate included in a kit may have 96, 384, or 1536 wells, or a 9×26 plate having 234 wells on 2.25 mm centers. In certain embodiments, one or more wells may include one or more reagents for use in carrying-out an assay with an array set of the subject invention, e.g., may include one or more reagents or reactants for performing amplification reactions such as PCR, analyte digestion, T7 generated cRNA, polymerase-based extensions, and the like. Such may be provided already in a respective well, or may be provided separately for application to a respective well by a user of the multiwell plate.

The kits may further include one or more additional components necessary for carrying out an array assay such as an analyte detection assay, and the like such as sample preparation reagents, buffers, labels, and the like. As such, the kits may include one or more containers such as vials or bottles, with each container containing a separate component for the assay, and reagents for carrying out an array assay such as a nucleic acid hybridization assay or the like. The kits may also include a denaturation reagent for denaturing the analyte, buffers such as hybridization buffers, wash mediums, enzyme substrates, reagents for generating a labeled target sample such as a labeled target nucleic acid sample, negative and positive controls.

The subject kits may also include written instructions for using the arrays in array assays such as hybridization assays or protein binding assays. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

The subject kits may also include computer program products with program code which can execute a method of the present invention.

In many embodiments of the subject kits, the components of the kit are packaged in a kit containment element to make a single, easily handled unit, where the kit containment element, e.g., box or analogous structure, may or may not be an airtight container, e.g., to further preserve the one or more biopolymeric arrays and reagents, if present, until use.

1. A method of performing an array assay using a set of chemical arrays held together by a common carrier, said method comprising:
(a) contacting said set of chemical arrays to multiwell plate containing samples to provide closed chambers about each array of said set; and
(b) maintaining said set of chemical arrays together with said multiwell plate under conditions sufficient to perform said array assay.

2. The method of claim 1, wherein said common carrier is a one-piece substrate having a surface on which the arrays are disposed.

3. The method of claim 2, further comprising separating said set of chemical arrays into multiple sub-sets of arrays, each carried on separate substrates.

4. The method of claim 3, wherein said separation occurs along markings present on said substrate prior to said separating.

5. The method of claim 4, wherein the substrate is glass and said markings comprise scores on said substrate to facilitate breaking of the glass.

6. The method of claim 3, wherein said separation occurs subsequent to said array assay.

7. The method of claim 3, wherein said common carrier comprises a substrate holder and said multiple sub-sets of arrays are mounted at different locations on said holder, wherein said separating comprises removing said separate substrates from said holder.

8. The method of claim 7, wherein the separate substrates are mounted in a series each adjacent the next.

9. The method of claim 3, wherein multiple array identifiers are present before separating such that after the separating each separated sub-set of arrays is carried on a separate substrate along with at least one of the array identifiers.

10. The method of claim 9, further comprising retrieving array layout information for a separated array sub-set using an array identifier carried on a same separate substrate as that separated array sub-set.

11. The method of claim 1, wherein said maintaining comprises providing a housing about said set of chemical arrays and said multiwell plate.

12. The method of claim 1, wherein said housing comprises a base and a cover.

13. The method of claim 12, wherein said common carrier serves as said base or said cover.

14. The method of claim 3, wherein said set of arrays on said common carrier before said separation consists of 2n by 3n arrays on the carrier.

15. The method of claim 14, wherein n is 4, 8 or 16.

16. The method of claim 14, wherein said common carrier has a length and width no greater than 150 mm by 100 mm.

17. The method of claim 16, wherein said set of arrays is separated into 4 sub-sets which have the same length and width.

18. The method of claim 3, further comprising receiving from a remote location the set of chemical arrays held together by the common carrier, along with an indication as to the locations along which separating occurs.

19. A method according to claim 18, wherein:
said common carrier comprises a one-piece substrate having a surface on which the arrays are disposed; and
said indication of the locations along which separating occurs comprises markings on the substrate as received.

20. A method according to claim 18, wherein:
said common carrier comprises a substrate holder;
said sub-sets of arrays are each carried on separate substrates mounted at different locations on said holder; and
said indication of the locations along which separating will occur comprises a visual indication of locations at which the separate substrates may be removed from said holder.

21. The method of claim 3, further comprising reading said separated sub-sets of the chemical arrays following said separation

22. A method comprising receiving from a remote location a result of reading performed by a method of claim 21.

23. A method comprising forwarding to a remote location a result of reading performed by a method of claim 21.

24. A method of using a set of chemical arrays held together by a common carrier in a reaction, said method comprising:
(a) contacting said set of chemical arrays to multiwell plate containing one or more reagents to provide closed chambers about each array of said set; and
(b) maintaining said set of chemical arrays together with said multiwell plate under conditions sufficient to perform said reaction.

25. The method of claim 24, wherein said reaction is an amplification reaction.

26. The method of claim 24, wherein said method is a cellular transvection reaction.

27. An apparatus comprising:
(a) a set of chemical arrays held together by a common carrier; and
(b) a multiwell plate to be used with said set of chemical arrays held together by a common carrier to provide closed chambers about each array of said set.

28. The apparatus of claim 27, wherein said common carrier is a one-piece substrate having a surface on which arrays are disposed.

29. The apparatus of claim 27, wherein said common carrier comprises a substrate holder and said set comprises multiple sub-sets of arrays each carried on separate substrates and each mounted at different locations on said holder.

30. The apparatus of claim 27, wherein said common carrier comprises an indication of locations along which said carrier should be separated so as to separate said set of chemical arrays into multiple sub-sets each with one or more arrays.

31. The apparatus of claim 27, further comprising a housing for maintaining said set of chemical arrays and said plate of wells together in an operative configuration to provide closed chambers about each array.

32. The apparatus of claim 31, wherein said housing comprises a base and a cover.

33. The apparatus of claim 32, wherein said common carrier serves as said base or said cover.

34. A method of using a set of chemical arrays held together by a common carrier with one or more arrays of the set having been previously exposed to a sample, comprising separating the set of chemical arrays into multiple sub-sets each with one or more arrays, wherein said separation occurs along markings present on the substrate prior to said separating, wherein said substrate is glass and said markings comprise scores on said substrate to facilitate breaking of said glass.

35. A method of using a set of chemical arrays held together by a common carrier with one or more arrays of the set having been previously exposed to a sample, comprising:
receiving from a remote location the set of chemical arrays held together by the common carrier, along with an indication as to the locations along which separating occurs; and
separating the set of chemical arrays into multiple sub-sets each with one or more arrays.

36. A kit comprising:
(a) a set of chemical arrays held together by a common carrier; and
(b) a multiwell plate to be used with said set of chemical arrays held together by a common carrier to provide closed chambers about each array of said set.

37. The kit of claim 36, further comprising a housing for maintaining said set of chemical arrays and said multiwell plate together in an operative configuration to provide closed chambers about each array.

38. The kit of claim 36, wherein said housing comprises a base and a cover.

39. The kit of claim 36, wherein at least one well of said multiwell plate comprises at least one reagent for use in a chemical reaction.
